(19) United States
(12) Patent Application Publication
(10) Pub. No.: US 2007/0177540 A1
(43) Pub. Date: Aug. 2, 2007

(54) System and method for transmitting data in wireless local area network

(76) Inventor: Seon-Soo Rue, Suwon-si (KR)

Correspondence Address: Robert E. Bushnell, Suite 300, 1522 K Street, N.W., Washington, DC, 20005-1202, US

(21) Appl. No.: 11/635,635

(22) Filed: Dec. 8, 2006

(30) Foreign Application Priority Data
Feb. 2, 2006 (KR) 10-2006-0010304

(51) Int. Cl. H04Q 7/00

(52) U.S. Cl. 370/328

(57) ABSTRACT

In a system and method for transmitting data in a wireless local area network (WLAN), the system includes: a wireless station which, when a No Acknowledge (ACK) function of the WLAN is applied, transmits a No ACK request message based on a protection mechanism according to a frame transmission condition based on link status packet information which is transmitted from an upper layer; and an access point for sequentially receiving a frame from the wireless station without a delay time depending on the No ACK request message received from the wireless station. The method comprises steps corresponding to the above functions of the wireless station and the access point of the disclosed system.

### CLAIM OF PRIORITY

This application makes reference to, incorporates the same herein, and claims all benefits accruing under 35 U.S.C. §119 from an application for SYSTEM AND METHOD FOR DATA TRANSMISSION IN WIRELESS LOCAL AREA NETWORK earlier filed in the Korean Intellectual Property Office on the 2^{nd} of February 2006 and there duly assigned Serial No. 2006-0010304.

### BACKGROUND OF THE INVENTION

1. Technical Field

The present invention relates to a system and method for transmitting data in a wireless local area network (WLAN).

2. Related Art

When an access point (AP) connected to the Internet is installed, it allows all instruments connected to a wireless local area network (WLAN) to connect to the Internet at the same time. Thus, it is utilized in real-time education such as Internet connection demonstrations, large academic seminars requiring direct download of data during the course of the seminar, workshops, or standardization conferences.

IEEE 802.11e[8] provides a standard for an improved quality of service (QoS) providing technique for real-time multimedia data transmission using a hybrid coordination function (HCF).

IEEE 802.11e provides differentiated access control to public media for data transmission with a QoS. For this, a total of eight priorities from 0 to 7 used in IEEE 802.11d and four access categories (AC) based on the priorities are used.

In other words, IEEE 802.11e provides a distributed coordination function (DCF) and a point coordination function (PCF) provided in IEEE 802.11 for conventional downward compatibility, and adds the HCF to provide the QoS. The HCF provides two media access mechanisms, i.e., enhanced distributed channel access (EDCA) which provides a prioritized QoS on the basis of contention, and HCF controlled channel access (HCCA) which provides polling and parameterized QoS.

A QoS station (QSTA) can acquire transmission opportunity (TXOP) through the channel access mechanisms. The QSTA does not have the authority to transmit frames until acquiring the TXOP. The QSTA transmits the frames during the TXOP according to a method defined in IEEE 802.11e.

In particular, a wireless local area network (WLAN) is allowed to receive an Acknowledge (ACK) message for data transmission, but a function called No ACK is mentioned in the IEEE 802.11e.

In other words, one method for enhancing data throughput involves the No ACK function. However, this function basically does not rely on a media access control (MAC) layer, and requires that an upper layer have reliability in data transmission.

In the art, the QSTA supporting the QoS determines the use or non-use of No ACK. The use of No ACK means No MAC-level recovery and reduces the reliability of the normal transmission of traffic.

In order to minimize the loss of reliability, an HCCA transmission method or a method for preventing transmission from other terminals to the extent possible by employing a request to send/clear to send (RTS/CTS) or other protection mechanisms is used.

However, these methods are not fundamental solutions to the problem of loss of reliability of traffic transmission which is caused by the use of No ACK.

In other words, these methods lack normal frame transmission reliability, and thus retransmission is often required when traffic is concentrated in a hot spot area or in an environment other than a single cell such as an office.

Handover (roaming between base stations) is performed in the near-boundary region. In this case, since a terminal is distant from a base station, packet error often occurs. Upon receipt of such a No ACK frame due to packet loss, an application is required to retransmit data. As a result, the data transmission bandwidth in a physical layer (PHY) is reduced due to inefficient transmission.

When the No ACK function is applied in all cases, there is a drawback in that data loss increases and data throughput decreases.

### SUMMARY OF THE INVENTION

It is an object of the present invention to provide a system and method for transmitting data in a wireless local area network (WLAN), wherein the system and method are capable of minimizing a data transmission reliability guarantee which is problematic when a QoS station (QSTA) supporting quality of service (QoS) uses a No Acknowledge (ACK) supporting function, and enhancing data throughput under all circumstances by selectively employing the No ACK function.

A first aspect of the present invention provides a system for transmitting data in a wireless local area network (WLAN). The system includes: a wireless station which, when a No Acknowledge (ACK) function of the WLAN is applied, transmits a No ACK request message based on a protection mechanism, according to a frame transmission condition based on link status packet information which is transmitted from an upper layer; and an access point for sequentially receiving a frame from the wireless station without a delay time depending on the No ACK request message transmitted from the wireless station.

The protection mechanism preferably transmits the frame after guaranteeing transmission opportunity (TXOP) using request to send/clear to send (RTS/CTS) or HCF Controlled Channel Access (HCCA).

The wireless station may request the access point for ACK frame transmission in order to check acquisition of a receiver signal strength indicator (RSSI) value and a data reception packet error rate at an initial time when power is switched on.

ACK frame transmission may be based on a normal ACK transmission method of IEEE 802.11 or an ACK transmission method of IEEE 802.11e.

When there is no data transmission/reception for a predetermined time after the power is switched on, the wireless station may request the access point for ACK frame transmission.

When the RSSI value is less than a threshold value, the wireless station may request the access point for ACK frame transmission.

When the data reception packet error rate exceeds a threshold value, the wireless station may request the access point for ACK frame transmission.

The wireless station may request the access point for ACK frame transmission when a handover is performed.

When the RSSI value exceeds a threshold value and the data reception packet error rate is less than the threshold value, the wireless station may employ the No ACK function and may sequentially transmit the frame to the access point without a delay time.

When receiving null data while sequentially receiving the frame from the wireless station without a delay time, the access point may transmit an ACK frame to the wireless station.

A second aspect of the present invention provides a method of transmitting data in a WLAN, the method including the steps of: when a No ACK function of a wireless station is applied, receiving link status packet information from an upper layer; transmitting a No ACK request message based on a protection mechanism according to a frame transmission condition based on the received link status packet information; and sequentially receiving a frame, which is transmitted from the wireless station, at an access point without a delay time depending on the No ACK request message transmitted from the wireless station.

The protection mechanism may transmit the frame after guaranteeing TXOP, using RTS/CTS or HCCA.

The access point may be requested for ACK frame transmission in order to check acquisition of an RSSI value and a data reception packet error rate at an initial time when power of the wireless station is switched on.

ACK frame transmission may be based on a normal ACK transmission method of IEEE 802.11 or an ACK transmission method of IEEE 802.11e.

When there is no data transmission/reception for a predetermined time after the power is switched on, the wireless station may request the access point for ACK frame transmission.

When the RSSI value is less than a threshold value, the wireless station may request the access point for ACK frame transmission.

When the data reception packet error rate exceeds a threshold value, the wireless station may request the access point for ACK frame transmission.

The wireless station may request the access point for ACK frame transmission when a handover is performed.

When the RSSI value exceeds a threshold value and the data reception packet error rate is less than the threshold value, the wireless station may employ the No ACK function and may sequentially transmit the frame to the access point without a delay time.

The method may further include the step of transmitting an ACK frame from the access point to the wireless station when receiving null data while sequentially receiving the frame from the wireless station without a delay time.

A third aspect of the present invention provides a method of transmitting data in a WLAN, the method including the steps of: after power is switched on, determining whether or not a time (T1) necessary for acquiring a link status (Link_Status) of the WLAN has expired; when the time (T1) necessary for acquiring the link status of the WLAN has expired, determining whether or not a time (T2) for determining data transmission/reception has expired; when the time (T2) for determining the data transmission/reception has expired, determining whether or not an RSSI value is at or above a threshold value; when the RSSI value is at or above the threshold value, determining whether or not a packet error rate is less than the threshold value; and, when the packet error rate is less than the threshold value, attempting No ACK transmission.

The method may further include the step of attempting ACK transmission when the time (T1) necessary for acquiring the link status of the WLAN has not expired.

ACK transmission may be based on a normal ACK transmission method of IEEE 802.11 or an ACK transmission method of IEEE 802.11e.

The method may further include the step of attempting ACK transmission when the RSSI value is less than the threshold value.

The method may further include the step of attempting ACK transmission when the packet error rate is at or above the threshold value.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 illustrates an example of a multiple-data transmission procedure in a wireless local area network;

FIG. 2 illustrates the network configuration of a system for transmitting data in a wireless local area network according to the present invention;

FIG. 3 illustrates a process of transmitting data in a wireless local area network according to the present invention; and

FIG. 4 illustrates an example of a No Acknowledge (ACK) transmission procedure according to the present invention.

### DETAILED DESCRIPTION OF THE INVENTION

Hereinafter, exemplary embodiments of the present invention will be described in detail with reference to the accompanying drawings. For the sake of clarity and conciseness, matters related to the invention that are well known in the art will not be described.

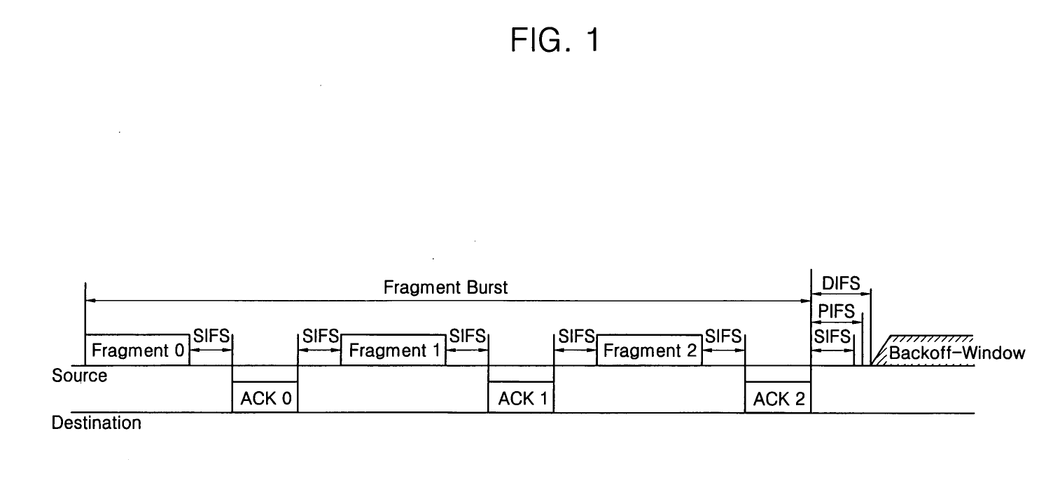

FIG. 1 illustrates an example of a multiple-data transmission procedure in a wireless local area network(WLAN).

As shown in FIG. 1, a multiple-fragment is transmitted from a source to a destination at a time interval of Short Interframe Space (SIFS). The source and destination are each a QoS Station (QSTA) or a QoS Access Point (QAP).

In other words, first, when “fragment 0” is transmitted from the source to the destination, a response message of “ACK 0” is transmitted from the destination after a time interval of SIFS.

Next, when “Fragment 1” is transmitted to the destination a time interval of SIFS after the source receives the “ACK 0”, a response message of “ACK 1” is transmitted from the destination after a time interval of SIFS.

After that, when “Fragment 2” is transmitted to the destination a time interval of SIFS after the source receives the “ACK 1”, a response message of “ACK 2” is transmitted from the destination after a time interval of SIFS.

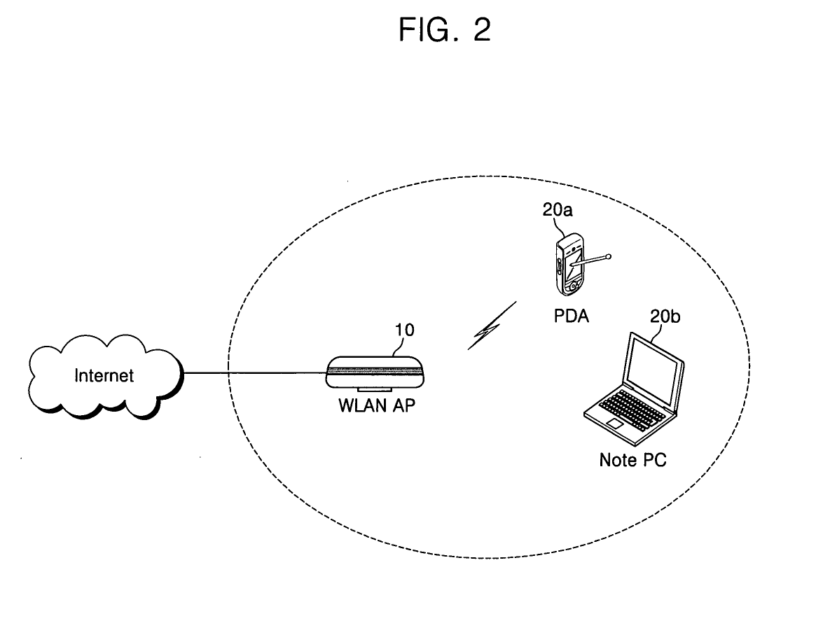

FIG. 2 illustrates the network configuration of a system for transmitting data in a WLAN according to the present invention.

As shown in FIG. 2, the inventive system includes a wireless local area network access point (WLAN AP) 10 and a plurality of stations 20a and 20b positioned within a boundary area of the WLAN AP 10. The WLAN AP 10 is associated with the Internet.

The access point 10, a QAP providing a No Acknowledge (ACK) function, connects with each of the stations 20a and 20b within the boundary area through the WLAN, and connects and associates with the Internet.

In other words, the access point 10 transmits a received frame to the Internet, and transmits a frame received over the Internet to each of the stations 20a and 20b, so that each of the stations 20a and 20b which connect with each other through the WLAN can connect with the Internet.

Each station 20a and 20b, a QSTA providing the No ACK function like the access point 10, connects to the access point 10 through the WLAN. Each station 20a and 20b wirelessly transmits a frame which is generated in dependence on a subscriber's selection, and outputs video information and sound information based on a received frame, thereby providing wireless network service to the subscriber.

In other words, the QSTA 20 receives from an upper layer a packet including information indicating a current WLAN link status (link_status), determines the current WLAN link status, and accordingly determines whether or not a No ACK scheme is applied every time before frame transmission.

That is, the QSTA 20 determines transmission packet ACK or not depending on a received data packet error rate and a receiver signal strength indicator (RSSI) value.

In other words, at an initial time after power is turned off/on, the QSTA 20 requests ACK data frame transmission in order to check RSSI value acquisition and the packet error rate for a predetermined period time.

In the case where data is not received for a predetermined period of time, the QSTA 20 detects only an RSSI level of the QAP and does not detect a packet error rate. Therefore, the QSTA 20 cannot detect a situation caused by a hidden node problem. In order to overcome such a drawback, the error rate should be checked together with the RSSI level of the QAP by receiving data, and thus ACK data frame transmission is requested.

When a data reception packet error exceeds a specific threshold, the QSTA 20 requests ACK data frame transmission.

When the RSSI level does not exceed the predetermined threshold, the QSTA 20 requests ACK data frame transmission. In other words, the QSTA 20 requests normal ACK frame transmission, thereby preventing retransmission caused by data packet loss.

In a handover, the QSTA 20 requests ACK data frame transmission. In other words, when roaming is determined, the QSTA 20 requests normal ACK frame transmission, thereby preventing retransmission caused by data packet loss.

In other words, when roaming is determined, there is movement at a range boundary, and the wireless environment may be adversely affected. Therefore, ACK frame transmission can reduce retransmission caused by data loss, which is more efficient than the reduction of bandwidth caused by an increase in ACK frame transmission.

In the above case, a transmission opportunity (TXOP) setting method mentioned in the 802.11e standard can be used for more efficient ACK transmission, thereby preventing inefficient retransmission caused by use of No ACK with low reliability.

In other words, with a good signal level and a clear wireless environment, the use of No ACK in a low-reliability media access control (MAC) layer can ideally prevent repeated ACK transmission to each MAC protocol data unit (MPDU) of the MAC layer every time, thereby improving data throughput.

In contrast, when there is no retransmission based on ACK frame reception a predetermined number of times, and there is no error for a received data packet, when a new packet is transmitted, a No ACK request can be transmitted, thereby allowing efficient use of data bandwidth.

In other words, when reception data has no error, or the RSSI level is high, or roaming is not needed, the No ACK function can be applied, thereby improving data throughput.

However, when the No ACK function is applied, a transmitter transmitting data does not receive the ACK frame. Therefore, the transmitter is allowed to receive the ACK frame at least once after transmitting at least a predetermined number of packets, or to check the RSSI value through request to send/clear to send (RTS/CTS) transmission.

In other words, when during a No ACK service, the RSSI level is low, ACK frame transmission is requested depending on a predefined RSSI, an ACK for transmission data (TX data) is normally received as a result of the RTS/CTS request, or there is no the TX data, a hidden problem together with RSSI is checked using a CTS response to a RTS request for dummy data transmission. This is used to determine ACK and No-ACK service.

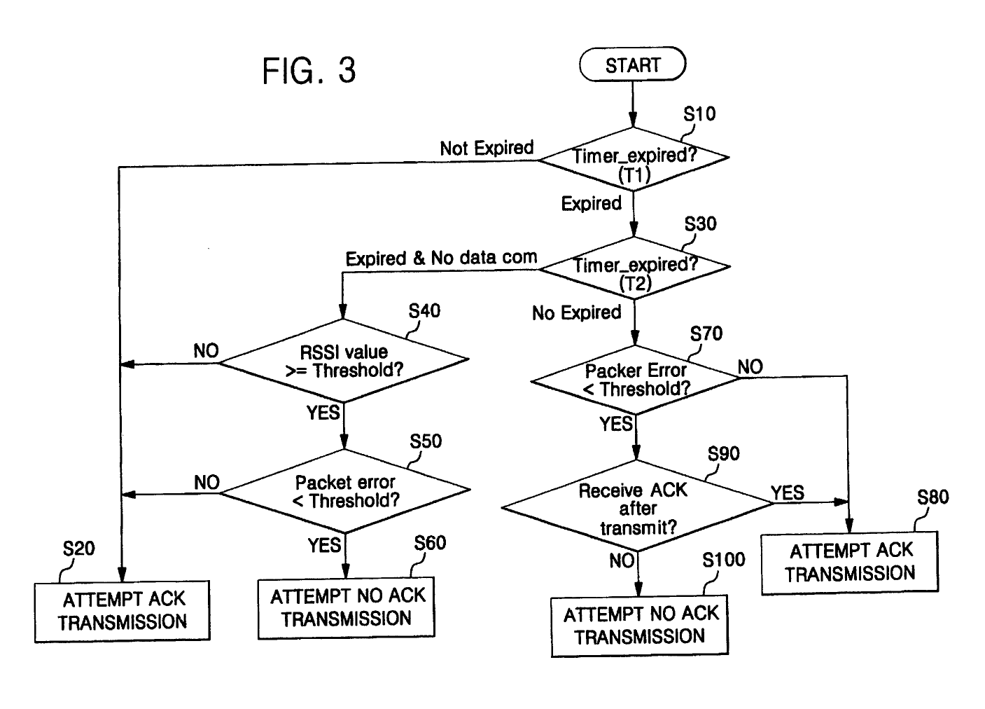

FIG. 3 illustrates a process of transmitting data in the WLAN according to the present invention.

As shown in FIG. 3, the QSTA determines whether or not, after power is switched on, a time (T1) necessary for acquiring the link status of the WLAN has expired (Step 10).

When it is determined that the time (T1) necessary for acquiring the link_status of the WLAN has not expired, ACK transmission is attempted (Step 20).

In this case, ACK transmission attempt is made on the basis of a normal ACK transmission method of IEEE 802.11, or an ACK transmission method of IEEE 802.11e.

Meanwhile, when the time (T1) necessary for acquiring the link status of the WLAN has expired, it is determined whether or not a predetermined time (T2) for determining data transmission/reception has expired (Step 30).

When it is determined that the predetermined time (T2) for determining the data transmission/reception has expired, that is, when there is no data transmission/reception during the predetermined time (T2), it is determined whether or not the RSSI value is at or above the threshold value (Step 40).

When it is determined that the RSSI value is less than the threshold, Step 20 of attempt of an ACK transmission is performed (Step 20).

When the RSSI value is at or above the threshold value, it is determined whether or not the packet error rate is less than the threshold value (Step 50).

When it is determined that the packet error rate is less than the threshold value, No ACK transmission is attempted (Step 60). When the packet error rate is at or above the threshold value, attempt of an ACK transmission is performed (Step 20).

Meanwhile, when the predetermined time (T2) for determining data transmission/reception has not expired in Step 30, it is determined whether or not the packet error rate is less than the threshold value (Step 70).

When it is determined that the packet error rate is at or above the threshold value, ACK transmission is attempted (Step 80).

However, when the packet error rate is less than the threshold value, it is determined whether or not the ACK frame should be received after frame transmission (Step 90).

When it is determined that the ACK frame need not be received after frame transmission, No ACK transmission is attempted (Step 100). When it is determined that the ACK frame should be received after frame transmission, attempt of ACK transmission is performed (Step 80).

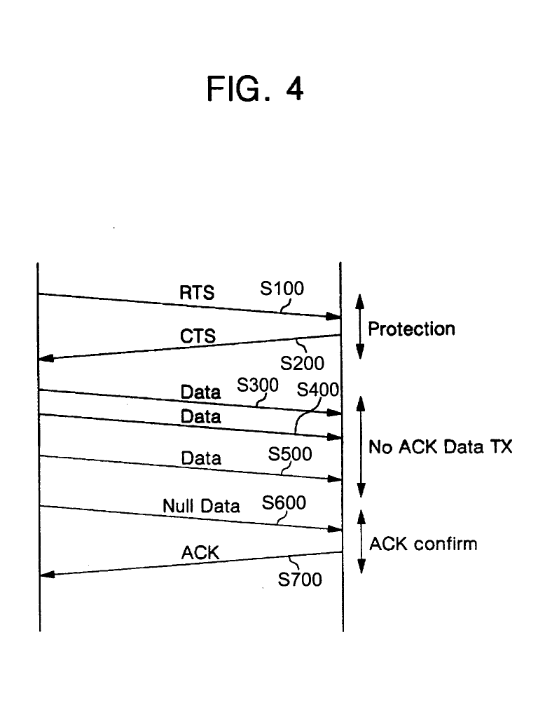

FIG. 4 illustrates an example of a No ACK transmission procedure according to the present invention.

As shown in FIG. 4, the RTS is transmitted and the CTS is received between the QSTA and the QAP (Steps 100 and 200).

Next, the No ACK function is applied, and data to be transmitted is sequentially transmitted (Steps 300, 400 and 500).

When null data is transmitted (Step 600) while sequentially transmitting the data using the applied No ACK function, the ACK frame is received (Step 700).

According to the present invention, when a WLAN with the No ACK function is used, the No ACK function is not always applied in all cases, but is applied in a selective manner based on the WLAN environment. Thus, the present invention reduces a decrease in latency data bandwidth due to ACK frame transmission, and in particular, in an errorless environment with a good RSSI level, the invention prevents ACK frame transmission, improves data transmission speed, guarantees reliable data transmission, and enhances data throughput in all environments.

While the present invention has been described with reference to exemplary embodiments thereof, it will be understood by those skilled in the art that various changes in form and detail may be made therein without departing from the scope of the present invention as defined by the following claims.

What is claimed is:

1. A system for transmitting data in a wireless local area network (WLAN), comprising:
a wireless station which, when a No Acknowledge (ACK) function of the WLAN is applied, transmits a No ACK request message based on a protection mechanism according to a frame transmission condition based on link status packet information which is transmitted from an upper layer; and
an access point for sequentially receiving a frame from the wireless station without a delay time depending on the No ACK request message transmitted from the wireless station.

2. The system of claim 1, wherein the protection mechanism transmits the frame after guaranteeing transmission opportunity (TXOP) using a request to send/clear to send (RTS/CTS).

3. The system of claim 1, wherein the protection mechanism transmits the frame after guaranteeing transmission opportunity (TXOP) using Hybrid Coordination Function Controlled Channel Access (HCCA).

4. The system of claim 1, wherein the wireless station requests the access point for ACK frame transmission in order to check acquisition of a receiver signal strength indicator (RSSI) value and a data reception packet error rate at an initial time when power is switched on.

5. The system of claim 4, wherein, when the RSSI value exceeds a threshold value, and the data reception packet error rate is less than another threshold value, the wireless station employs the No ACK function and sequentially transmits the frame to the access point without the delay time.

6. The system of claim 4, wherein the ACK frame transmission is based on one of a normal ACK transmission method of IEEE 802.11 and an ACK transmission method of IEEE 802.11e.

7. The system of claim 6, wherein, when there is no data transmission/reception for a predetermined period of time after the power is switched on, the wireless station requests the access point for ACK frame transmission.

8. The system of claim 6, wherein, when the RSSI value is less than a threshold value, the wireless station requests the access point for ACK frame transmission.

9. The system of claim 6, wherein, when the data reception packet error rate exceeds a threshold value, the wireless station requests the access point for ACK frame transmission.

10. The system of claim 1, wherein the wireless station requests the access point for ACK frame transmission when a handover is performed.

11. The system of claim 1, wherein, when receiving null data while sequentially receiving the frame from the wireless station without the delay time, the access point transmits an ACK frame to the wireless station.

12. A method of transmitting data in a wireless local area network (WLAN), the method comprising the steps of:
when a No Acknowledge (ACK) function of a wireless station is applied, receiving link status packet information from an upper layer;
transmitting, at the wireless station, a No ACK request message based on a protection mechanism according to a frame transmission condition based on the received link status packet information; and
sequentially receiving a frame, which is transmitted from the wireless station, at an access point without a delay time depending on the No ACK request message transmitted from the wireless station.

13. The method of claim 12, wherein the protection mechanism transmits the frame after guaranteeing transmission opportunity (TXOP) using a request to send/clear to send (RTS/CTS).

14. The method of claim 12, wherein the protection mechanism transmits the frame after guaranteeing transmission opportunity (TXOP) using Hybrid Coordination Function Controlled Channel Access (HCCA).

15. The method of claim 12, wherein the access point is requested for ACK frame transmission in order to check acquisition of a receiver signal strength indicator (RSSI) value and a data reception packet error rate at an initial time when power of the wireless terminal is switched on.

16. The method of claim 15, wherein, when the RSSI value exceeds a threshold value and the data reception packet error rate is less than another threshold value, the wireless station employs the No ACK function and sequentially transmits the frame to the access point without the delay time.

17. The method of claim 15, wherein ACK frame transmission is based on one of a normal ACK transmission method of IEEE 802.11 and an ACK transmission method of IEEE 802.11e.

18. The method of claim 17, wherein, when there is no data transmission/reception for a predetermined period of time after the power is switched on, the wireless station requests the access point for ACK frame transmission.

19. The method of claim 17, wherein, when the RSSI value is less than a threshold value, the wireless station requests the access point for ACK frame transmission.

20. The method of claim 17, wherein, when the data reception packet error rate exceeds a threshold value, the wireless station requests the access point for ACK frame transmission.

21. The method of claim 12, wherein the wireless station requests the access point for ACK frame transmission when a handover is performed.

22. The method of claim 12, further comprising the step of transmitting an ACK frame from the access point to the wireless station when receiving null data while sequentially receiving the frame from the wireless station without the delay time.

23. A method of transmitting data in a wireless local area network (WLAN), the method comprising the steps of:
after power is switched on, determining whether a time (T1) necessary for acquiring a link status (Link_Status) of the WLAN has expired;
when the time (T1) necessary for acquiring the link status of the WLAN has expired, determining whether a time (T2) for determining data transmission/reception has expired;
when the time (T2) for determining the data transmission/reception has expired, determining whether a receiver signal strength indicator (RSSI) value is not less than a threshold value;
when the RSSI value is not less than the threshold value, determining whether a packet error rate is less than another threshold value; and
when the packet error rate is less than said another threshold value, attempting a No Acknowledge (ACK) transmission.

24. The method of claim 23, further comprising the step of attempting an ACK transmission when the time (T1) necessary for acquiring the link status of the WLAN has not expired.

25. The method of claim 24, wherein the ACK transmission is based on one of a normal ACK transmission method of IEEE 802.11 and an ACK transmission method of IEEE 802.11e.

26. The method of claim 23, further comprising the step of attempting an ACK transmission when the RSSI value is less than the threshold value.

27. The method of claim 23, further comprising the step of attempting an ACK transmission when the packet error rate is not less than said another threshold value.
